(19) United States
(12) Patent Application Publication
(10) Pub. No.: US 2015/0175244 A1
(43) Pub. Date: Jun. 25, 2015

(54) Deployment Device

(71) Applicant: Deep Blue Engineering UK Limited, Hereford (GB)

(72) Inventor: David Wade Webster, Hereford (GB)

(73) Assignee: Deep Blue Engineering UK Limited, Hereford (GB)

(21) Appl. No.: 14/580,466

(22) Filed: Dec. 23, 2014

(30) Foreign Application Priority Data
Dec. 23, 2013 (GB) 1322860.6

(51) Int. Cl. B63B 35/04; B25J 15/00; B25J 11/00; B63B 21/66; B63B 22/20

(52) U.S. Cl. CPC B63B 35/04; B63B 21/66; B63B 22/20; B25J 11/005; B25J 15/0028; B63B 2035/008

(57) ABSTRACT

A deployment device is described which comprises a support frame 12 provided with buoyancy tanks 20, the buoyancy of which is adjustable, the support frame 12 being adapted for use in carrying and/or deployment of a payload.

### CROSS REFERENCE TO RELATED APPLICATION

The present application claims priority of British Patent Application 1322860.6, filed Dec. 23, 2013, the content of which is incorporated herein by reference in its entirety.

### FIELD OF THE INVENTION

This invention relates to a deployment device for use in the deployment of materials in underwater locations. By way of example, it may be used in the deployment of cables, hoses, umbilicals or the like on the sea bed. However, it may be used in a number of other applications, including the laying of pipes, installation of equipment or the like.

### BACKGROUND OF THE INVENTION

The deployment of cables, hoses, umbilicals or the like (referred to hereinafter as cables) in underwater locations is typically achieved by delivering the cables in spooled or coiled form to the underwater location, and using a remotely operated underwater vehicle (ROV) to pull the end of the cable from the spool or coil to a position in which the end of the cable can be connected to, for example, an underwater located distribution device or a piece of underwater equipment. The cables used in this context are typically heavy and difficult to manoeuvre. It has been found that whilst an ROV is able to manoeuvre relatively short lengths of cable, where the distance between the coil or spool and the underwater location to which the end of the cable is to be moved is greater than about 75 m, the ROV is unable to apply a sufficient load to move the cable as required. Assuming that the spool or coil is accurately positioned at the midpoint between the locations at which the cable is to be connected, it will be appreciated that this technique is only suitable for use in applications in which the overall cable length is around 150m or less. There are many applications in which it is desired to install cables of length significantly greater than this, and the technique is unsuitable for use in these applications, or requires the cable to be installed in a number of interconnected relatively short lengths or segments.

An alternative approach is to deploy the cables directly from the side of a support ship. However, where the cable to be deployed is heavy and is to be deployed to a relatively great depth, the weight of the unsupported length of cable between the ship and the sea bed must be carried by the ship, placing significant constraints on the size of ship which can be used.

GB2440337 describes a deployment apparatus for use in the deployment of cables in underwater locations. The apparatus includes a rotatable housing within which a cable to be deployed is spooled. In use, the apparatus is carried, for example by ship, to the location in which the cable is to be deployed. Once at that location, the apparatus is lowered into the water, suspended by a line from the ship. An end of the cable can be connected, for example using an ROV, to an underwater device. Subsequent movement of the ship moves the apparatus resulting in the cable being pulled from the housing, during which the housing rotates.

Whilst such an arrangement allows relatively long lengths of cable to be deployed, the size and weight of the apparatus, especially when the cable to be deployed is stowed therein, is significant and places severe constraints on the size of ship that must be used in deployment of the cable, especially if deployment is to be undertaken when the sea conditions are not good. Typically, the lift line used to lift the apparatus out of the ship and control its depth in the water is off centre, being supported by a lift arm which extends over the side of the ship. The weight of the apparatus may be sufficient that it would cause the ship to heal over, in use. Clearly, therefore, in order to use such an apparatus in the deployment of cables or the like, care must be taken to ensure that the ship used is capable of accommodating the loads that will be experienced, in use.

Furthermore, ROVS or the like are required to connect the ends of the cable to underwater located equipment. Installation is thus a relatively complex, expensive and time consuming operation. Also, as currents and other sea conditions may result in the position of the apparatus being difficult to control, accurately positioning the cable may be difficult to achieve.

### SUMMARY OF THE INVENTION

It is an object of the invention to provide a deployment device in which at least some of the disadvantages set out hereinbefore are overcome or are of reduced effect.

According to one aspect of the invention there is provided a deployment device comprising a support frame provided with buoyancy tanks, the buoyancy of which is adjustable, the support frame being adapted for use in carrying and/or deployment of a payload.

The payload may comprise a cable, for example wound onto a reel. The reel is conveniently releasably securable to the frame. By way of example, the frame may define an opening of dimensions greater than the payload, allowing the payload to be introduced through the opening of the frame, and secured in position, conveniently whilst the frame is floating. The payload may thus be supported whilst suspended beneath the frame.

Where the payload comprises a reel, it is conveniently rotatably supported by a mounting releasably securable to the frame.

The frame is conveniently adapted to be tethered, in use, to a support ship by a tether line such that propulsion of the support ship can be used to move the frame.

It will be appreciated that such an arrangement is advantageous in that the support ship need only be capable of carrying the payload and transferring the payload to the frame. The frame can be transported separately. The size support ship used can thus be reduced, allowing cost savings to be made and increasing operational flexibility.

In use, by appropriate adjustment of the buoyancy of the frame, it will be appreciated that the loadings experienced by the support ship during deployment of the payload can be reduced as the tension within a tethering line can be reduced. Should there be a need to abandon deployment operations, for example as a result of bad weather, by appropriate control over the buoyancy of the device so that the device is of substantially neutral buoyancy, the device can be left close to the sea bed, but not resting upon the sea bed. The need to provide a mud foot or the like can thus be avoided.

The frame conveniently has one or more manipulator arrangements mounted thereon. The manipulator arrangement preferably includes a movable manipulator arm, a free end of which carries controllable, movable manipulator claws. The manipulator arrangement is preferably remotely controllable, for example from the support ship.

Control signals may be supplied to the manipulator arrangement via communications lines incorporated in or attached to the tether line.

The manipulator arrangement may incorporate plough means.

By providing a manipulator arrangement, it will be appreciated that the need to use a separate ROV or the like to complete the installation can be avoided. The deployment cost and process complexity can thus be reduced.

A drive arrangement may be provided and operable to drive the payload to a datum position. For example, where the payload includes a rotatable reel, the drive arrangement may be operable to drive to the reel to a predetermined datum rotary position. The drive arrangement may comprise a cam associated with the reel and matingly engageable with a drive member such that engagement between the drive member and the cam drives the reel towards the datum position.

Thruster means are conveniently provided to allow manoeuvring of the frame independently of the support ship.

The invention will further be described, by way of example, with reference to the accompanying drawings, in which:

### BRIEF DESCRIPTION OF THE DRAWINGS

FIG. 1 is a view illustrating a deployment device in accordance with one aspect of the invention;

FIGS. 2 to 4 are views illustrating parts of the device of FIG. 1 and illustrating a number of optional additions; and

FIG. 5 is a diagrammatic view illustrating the device in use.

### DETAILED DESCRIPTION OF THE DRAWINGS

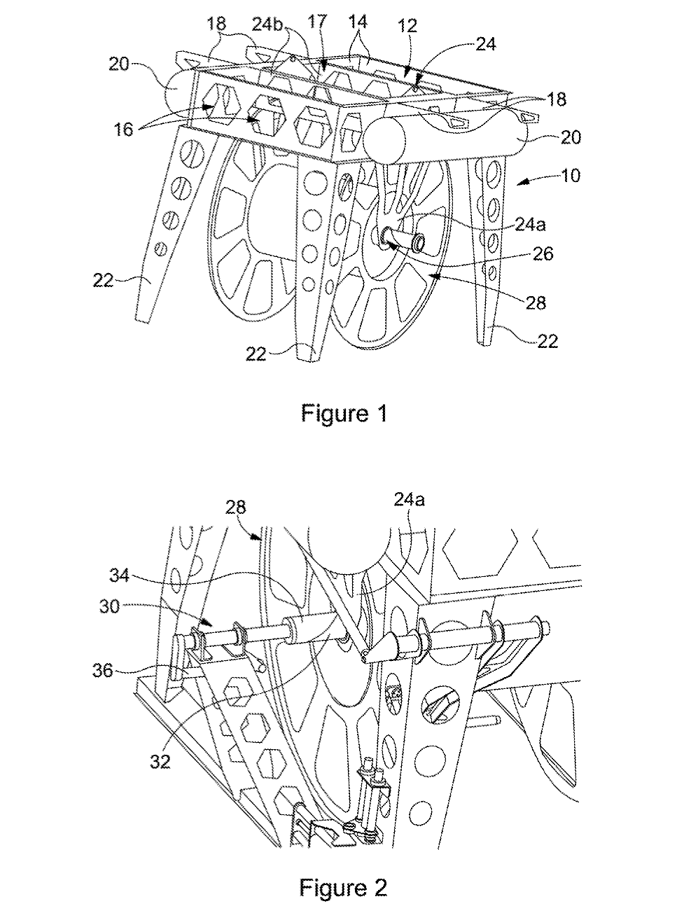

Referring firstly to FIG. 1, a deployment device 10 is illustrated. The deployment device 10 comprises an upper frame 12 of generally rectangular form and constructed from interconnected lengths 14 of steel, for example welded to one another. As illustrated, each length 14 of steel is conveniently formed with a series of openings 16, thereby reducing the weight of the device by avoiding including unnecessarily high quantities of material. The size and positioning of the openings 16 are chosen such that the strength and rigidity of the frame 12 is maintained at an acceptable level.

Two opposing sides of the frame 12 includes a pair of outwardly projecting wings 18, each pair of wings 18 being adapted to carry a buoyancy tank 20. The tanks 20 are of metallic construction and are dimensioned such that, when air or gas filled, they provide sufficient buoyancy to the device 10 that it is able to carry a payload, in use, whilst avoiding the application of excessively large loads to an associated support ship as discussed below. The shape of each tank 20 is chosen to assist in its ability to withstand the pressures applied thereto, in use.

Whilst not illustrated, a control system including a series of control valves is provided to allow control over the content of each tank 20, controlling the proportion of each tank 20 filled with air or another gas and the proportion filled with, for example, water. In so doing, the control system controls the level of buoyancy provided to the device by the tanks 20. Furthermore, the control system preferably controls the pressure within each tank 20, allowing the pressures therein to be maintained at a sufficiently high level as to be able to withstand the externally applied pressures which arise when the device is in use underwater. The control valves are conveniently operable to allow the controlled venting of gas from the tanks 20, and to allow the controlled ingress or flooding of the tanks 20 with sea water. Conveniently, the device 10 includes compressed gas tanks or a line whereby gas can be supplied to the device 10 from the surface to permit controlled charging of the tanks 20 with gas and displacement of water therefrom.

The device 10 further includes legs 22 depending downwardly from each corner of the frame 12 to allow the device 10 to stand upon a surface.

The device 10 is adapted to carry a payload and to permit deployment of the payload underwater. In the arrangement illustrated, frame 12 defines an opening 17 through which the payload can be introduced. The payload takes the form of a cable to be installed on the sea bed. To achieve this, the device 10 includes a mounting 24 which is insertable into the opening 17 and releasably securable to the frame 12, extending downwardly therefrom. The mounting 24 includes sides 24a of generally triangular form connected to one another by cross beams 24b. Each side 24a includes, adjacent its lowermost apex, an opening through which a spindle 26 extends. The spindle 26 carries a reel 28 upon which the cable is carried, in use, prior to deployment. The spindle 26 and reel 28 are freely rotatable relative to the mounting 24 thereby allowing a cable wound upon the reel 28 to be withdrawn therefrom during deployment.

The legs 22 are conveniently of a length sufficient to allow the device 10 to stand upon a surface whilst supporting the reel 28 clear of the surface.

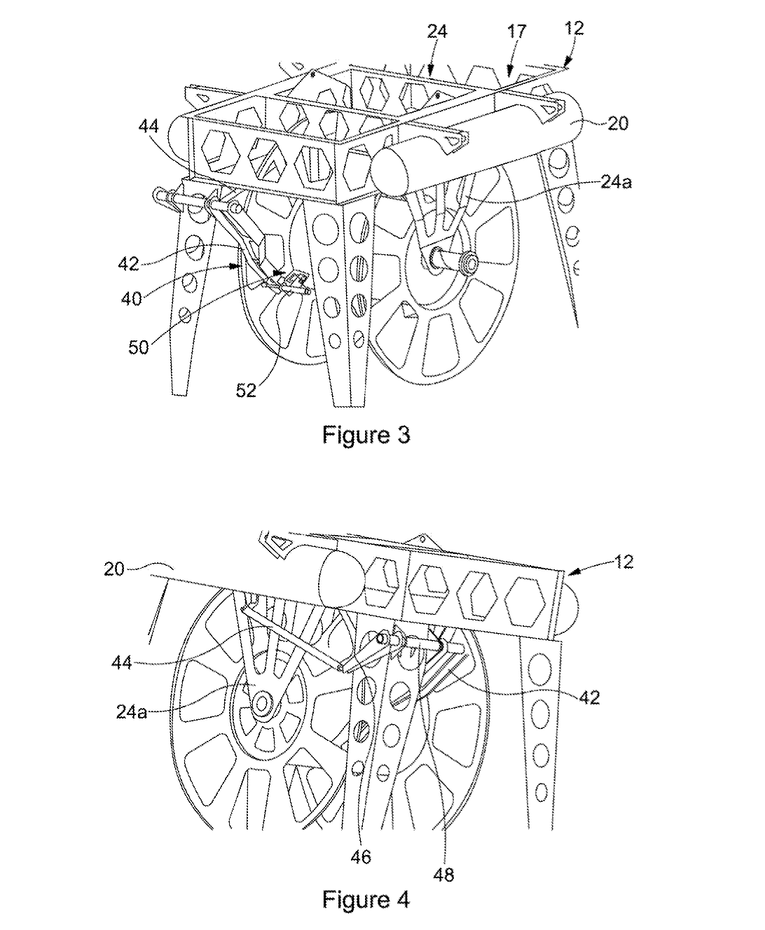

As shown in FIG. 2, the device 10 conveniently includes a drive mechanism 30 whereby the reel 28 can be driven to a known datum rotary position relative to the device. The drive mechanism 30 conveniently takes the form of a cam 32 secured to an end of the spindle 26 and cooperable with an axially movable drive member 34. The cam 32 and drive member 34 have interengaging surfaces which are shaped to mate with one another in just one relative angular position. The drive member 34, whilst being capable of axial movement, is mounted in such a manner that angular movement thereof is not permitted. An actuator 36, conveniently in the form of a hydraulic or pneumatic ram, is mounted to drive the drive member 34 for axial movement. In use, when the drive member 34 is disengaged from the cam 32 the spindle 26, and hence the reel 28, is free to rotate. Operation of the actuator 36 to force the drive member 34 into engagement with the cam 32 results in the application of a load to the cam 32 urging the cam 32 for angular movement until the cam 32, and hence the spindle 26 and reel 28, reaches the datum angular position in which the cam 32 and drive member 34 mate with one another. Once in this position, the cam 32, spindle 26 and reel 28 are locked against further angular movement.

Referring next to FIGS. 3 and 4, a manipulator arrangement 40 is attached to the device 10 to assist in deployment of the payload. The manipulator arrangement 40 comprises a movable arm 42 pivotally attached to the device 10, an actuator 44 being operable to drive the arm 42 for pivotal movement. As shown in FIG. 4, this is conveniently accomplished by an end of the actuator 44 engaging a crank 46 secured to a pivot pin 48 to which the arm 42 is also secured. To the free end of the arm 42 is attached a manipulator 50 and associated actuators 52 to allow the orientation of the manipulator 50 relative to the arm 42 to be adjusted and to allow opening and closing of claws of the manipulator 50.

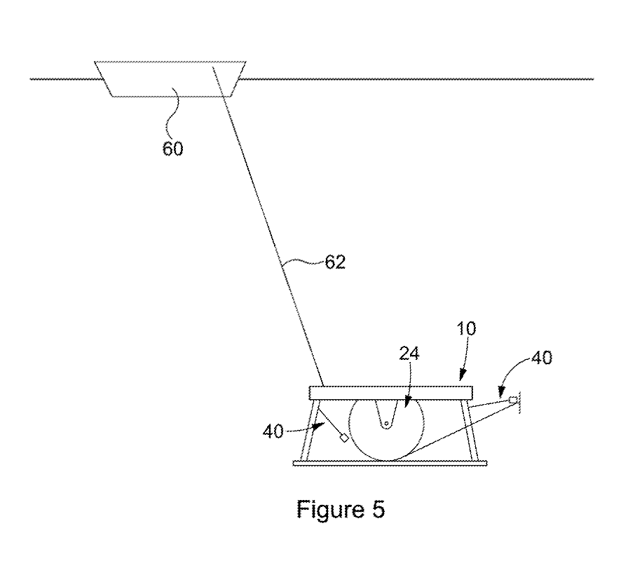

In use, in order to deploy a cable in a selected location, the deployment device 10 is delivered to the location, for example by being carried thereto aboard a support ship or by being towed. The cable to be delivered is also delivered to the site, for example upon a suitable support ship 60 (see FIG. 5). The cable is conveniently transported stowed upon a reel 28 of the form illustrated. Where the cable has connectors such as stabplates secured to the ends thereof, then the manner in which the cable is wound onto the reel 28 is conveniently such that the stabplates are located at predetermined rotary positions relative thereto. It will be appreciated that as the device 10 and the payload can be transported to the site separately, the support ship may be relatively small.

Once at the site, the deployment device 10 is tethered to the support ship 60 by a line 62, and by mooring lines. The reel 28 containing the cable is fitted into the mounting 24, being secured thereto by the spindle 26, and the reel 28 and mounting 24 are lowered over the side of the ship 60 and introduced through the opening 17 of the frame 12 such that the reel 28 is positioned beneath the frame 12. The mounting 24 is then secured in position on the frame 12, for example by means of appropriate latches (not shown). Once secured in position, operation of the drive mechanism 30 drives the reel 28 to a known rotary position. Since the position of the stabplates relative to the reel 28 is predetermined, and as the reel 28 is driven to a known rotary position, it will be appreciated that the positions of the stabplates can be determined.

The line 62 not only provides a physical connection between the support ship 60 and the device 10, but conveniently also incorporates communication lines whereby control signals can be transmitted to the device 10 and feedback information from the device 10 can be supplied to an operator located, for example, on the support ship 60.

Either before or after securing the payload in position, the control system is operated to adjust the proportion of the tanks 20 filled with air or another gas and the proportion containing liquid such as sea water, and thus adjust the buoyancy of the device 10. Conveniently, the buoyancy of the device 10 is set such that, once the payload is attached thereto, the combination of the device 10 and payload is negatively buoyant whilst the device 10 is at the surface and so will sink, but that the tension within the line 62 by which the device 10 is tethered to the support ship 60 is relatively small and thus can be accommodated by the support ship 60. By controlling the buoyancy of the device 10 in this manner, it will be appreciated that the support ship 60 can be used to control the position of the device 10 and to drive the device 10 for movement over or relative to the sea bed, the negative buoyancy of the device 10 maintaining the line 62 under tension. However, the buoyancy provided by the contents of the tanks 20 results in the tension experienced by the line 62 being considerably lower than would be the case if the tanks 20 were not present. Accordingly, the load experienced by the support ship 60 is considerably reduced and as a result, deployment may be achieved using a smaller support ship than would otherwise be required. Likewise, as the device 10 can be moved to the site independently of the cable to be deployed, and as the cable to be deployed can be installed on the device 10 with the device 10 in the water rather than on-board the support ship 60, limitations restricting the use of relatively small support ships 60 are avoided.

The device 10 is lowered to a depth adjacent the sea bed in the location at which an end of the cable is to be deployed. It will be appreciated that as the device is lowered, the external pressures applied to the tanks 20 and other parts of the device 10 will increase. If desired, the control system may be operated in such a manner as to result in additional gas or water being supplied to the tanks 20 whilst the device 10 is being lowered to increase the internal pressures thereof and so enhance their ability to withstand the increases in external pressure. Clearly, depending upon whether additional gas or water is supplied to the tanks 20, the buoyancy of the device 10 may change. If appropriate, the adjustment in the buoyancy of the device may be such as to result in the device being of substantially neutral buoyancy when at the depth at which the payload is to be deployed. By way of example, it is envisaged that deployment of the payload will occur with the device 10 at a height of around 10-30 m above the sea bed. However, the invention is not restricted in this regard.

In this position, as the locations of the stabplates are known, the manipulator arrangement 40 can be controlled in such a manner as to grip and move the stabplate to a desired position, for example securing it to a piece of subsea located equipment. Once correctly positioned, the manipulator arrangement 40 can release the stabplate, and the drive mechanism 30 released to allow the reel 28 to rotate freely relative to the remainder of the device 10. Subsequent movement of the device 10 arising from movement of the support ship 60 results in the cable being drawn from the reel 28, the reel 28 rotating during such movement. It will be appreciated that as the buoyancy of the device 10 is controlled, in use, as outlined hereinbefore, the tension in the line 62 and the load experienced by the support ship 60 is relatively low. Where the device 10 is of substantially neutral buoyancy, there may be occasions where sufficient slack can be maintained in the line 62 that the device 10 can remain at its desired depth during deployment despite heave resulting in significant movement of the support ship 60.

Whilst not illustrated, the manipulator arrangement 40 may be adapted to carry or drag a plough or the like operable such that upon movement of the device 10, the plough serves to cut a trench in the sea bed within which the cable is laid. The plough may further serve to cover the cable. It will be appreciated that, in such an arrangement, the ploughing load will be transmitted through the line 62 to the support ship 60.

During deployment, it will be appreciated that the overall weight of the device 10 and payload will reduce. Preferably, the control system operates the control valves continuously or periodically during deployment to adjust the buoyancy of the device 10, maintaining it at substantially the desired level during deployment. Typically, this would be achieved by the gradual introduction of additional water into the tanks 20 and venting of a proportion of the gas therefrom. However, the intention is that this adjustment will not result in complete flooding of the tanks 20 as this would result in the load being borne by the tether line 62 increasing undesirably.

As the device approaches the location at which the opposite end of the cable is to be deployed, the drive mechanism 30 is again operated to move the reel 28 to the datum rotary position. Once in this position, as the location of the stabplate connected to that end of the cable is known, the manipulator arrangement 40 may again be used to grip and move the stabplate to the desired location.

If desired, as illustrated in FIG. 5, a second manipulator arrangement 40 may be may be provided for use in handling the stabplate.

Whilst not illustrated, the device 10 may incorporate camera means whereby images of the vicinity in which the device 10 is being used can be captured, for example for transmission to a surface or ship located operator who is controlling the operation of the device. Such images will assist the operator accurately controlling the operation of the manipulator arrangement 40.

Once the cable has been deployed in this fashion, the device 10 is recovered to the surface, for example by winching in of the tether line 62. if the device includes pressurised gas tanks, or includes means whereby gas can be supplied via the tether line 62 to the device 10, then the control system may be operated to introduce additional gas into the buoyancy tanks, displacing some of the water therefrom, to increase the buoyancy and so reduce the load in the tether line required to recover the device 10. Once at the surface, the mounting 24 may be removed and replaced to permit the use of the device 10 in the deployment of another length of cable or in the deployment of another form of payload.

Whilst in the arrangement described hereinbefore with reference to the accompanying drawings, the device 10 is arranged to be propelled solely by movement of the support ship 60 and adjustment of the paid out length of the line 62, it will be appreciated that this need not always be the case. By way of example, if desired the device 10 may incorporate one or more thruster devices operable to positively drive the device 10 for movement. Conveniently the, or at least one of the, thruster device is adjustable or operable to permit steering of the device 10. It will be appreciated that the provision and use of such thruster devices permits accurate control over the position of the device 10, and thus permits accurate control over the location in which the payload is deployed. Such an arrangement is thought to be of particular benefit where the device 10 is used in the deployment of a cable, the ends of which are fitted with stabplates which are to be connected to subsea located equipment. Whilst the thruster devices may permit operation of the device 10 substantially independently of the support ship 60, it is envisaged that the thruster devices will, in practise, be used in combination with propulsion provided by movement of the support ship 60 so that the movement of the support ship 60 results in the device 10 being positioned approximately in the desired position, the thruster devices then being used to more precisely position the device 10. When deploying a cable or the like it is anticipated that it will primarily be the propulsion of the ship that drives the device 10 for movement, the thruster device serving primarily to fine tune the position and steering of the device 10.

It will be appreciated that as the tension within the tethering line 62 is relatively low, the buoyancy of the device 10 being controlled in such a manner as to achieve this, the device can be used in the deployment of heavy payloads, for example in the region of 100 tonnes. In the context of laying cables, it will be appreciated that the invention permits very long cable lengths to be deployed without requiring the cable to be divided into sections which must be interconnected with one another. The use of the invention avoids the need for significant unsupported lengths of cable to be borne by the support ship and so these constraints on the size of support ship are avoided.

Whilst the description hereinbefore is of one embodiment of the invention and a number of variants, it will be appreciated that a wide range of modifications and alterations may be made without departing from the scope of the invention as defined by the appended claims. By way of example, where used in the deployment of cables or the like, the reel 28 could be replaced by a device substantially of the form described in GB2440337. Furthermore, whilst the description hereinbefore relates primarily to an arrangement intended for use in the laying of cables in subsea locations, the invention is not restricted in this regard. It could, for example, be adapted for use in carrying equipment to be located on the sea bed to its desired location and in the installation of the equipment in such locations.

A further application in which the invention may be used is in the deployment of heavy pipe or the like. Where a heavy pipe is deployed from a ship, the load of the unsupported length of pipe between the ship and the sea bed must be borne, typically by the ship. As described hereinbefore, such an arrangement places significant constraints on the type of ship which can be used. In accordance with an embodiment of the invention, the device 10 described hereinbefore may be modified to replace the reel 28 and mounting 24 with a pipe support device. The pipe support device conveniently includes an opening through which the pipe to be deployed extends, and grip means whereby the pipe is gripped. By appropriate control over the buoyancy of the device 10, it will be appreciated that the size of the load which must be borne by the support ship can be reduced, much of the pipe weight being borne by the device 10.

To permit the laying of the pipe to be undertaken in a substantially continuous fashion, the grip means may take a form similar to caterpillar tracks.

Depending upon the weight of the pipe and the depth at which it is to be deployed, it may be desirable to provide two or more such arrangements at different depths to provide support to the pipe and so reduce the loadings experienced by the support ship.

In the arrangements described hereinbefore, the buoyancy of the support frame is adjusted by venting gas from the buoyancy tanks, allowing water to replace the vented gas to reduce the buoyancy, or by supplying additional gas to the buoyancy tanks, displacing water therefrom to increase the buoyancy. It will be appreciated that such a gas displacement arrangement represents just one option and that the buoyancy could alternatively be adjusted by using a void-based arrangement in which one or more pumps are used to control the quantity of water within the buoyancy tanks. In such an arrangement, to increase the buoyancy at least some of the water may be pumped from the tanks drawing a vacuum or partial vacuum within the buoyancy tanks, the subsequent introduction or reintroduction of water into the tanks under the control of appropriate valves reducing the buoyancy of the support frame. Such an arrangement is advantageous in that there is no need to provide a gas supply, for example in the form of compressed gas tanks or a line to the surface to allow the supply of gas to the buoyancy tanks.

Whilst specific embodiments of the device are described hereinbefore, a number of modifications and alterations may be made thereto without departing from the scope of the invention.

1. A deployment device comprising a support frame provided with buoyancy tanks, the buoyancy of which is adjustable, the support frame being adapted for use in carrying and/or deployment of a payload.

2. A device according to claim 1, wherein the frame defines an opening of dimensions greater than the payload, the payload being arranged to be introduced through the opening of the frame to be supported beneath the frame, in use.

3. A device according to claim 2, wherein the payload is arranged to be introduced through the opening of the frame whilst the frame is floating.

4. A device according to claim 2, wherein the payload is releasably securable to the frame.

5. A device according to claim 1, wherein the payload comprises a cable.

6. A device according to claim 5, wherein the cable is wound onto a reel.

7. A device according to claim 6, wherein the reel is rotatably supported by a mounting releasably securable to the frame.

8. A device according to claim 1, wherein the frame is adapted to be tethered, in use, to a support ship by a tether line such that propulsion of the support ship can be used to move the frame.

9. A device according to claim 8, wherein the buoyancy of the device is controlled in such a manner as to maintain the tension in the tether line at a level below a predetermined level.

10. A device according to claim 9, wherein the buoyancy of the device is controllable such that the device is of substantially neutral buoyancy whilst carrying the payload.

11. A device according to claim 1, wherein the device includes a control system incorporating control valves operable to control the buoyancy of the device.

12. A device according to claim 1, further comprising one or more manipulator arrangements.

13. A device according to claim 12, wherein the manipulator arrangement includes a movable manipulator arm, a free end of which carries controllable, movable manipulator claws.

14. A device according to claim 13, wherein the manipulator arrangement is remotely controllable.

15. A device according to claim 14, wherein the manipulator arrangement is controllable from the support ship.

16. A device according to claim 12, wherein the manipulator arrangement is controlled using control signals supplied to the manipulator arrangement via communications lines incorporated in or attached to the tether line.

17. A device according to claim 12, wherein the manipulator arrangement incorporates plough means.

18. A device according to claim 1, further comprising a drive arrangement operable to drive the payload to a datum position.

19. A device according to claim 18, wherein where the payload includes a rotatable reel, the drive arrangement is operable to drive to the reel to a predetermined datum rotary position.

20. A device according to claim 19, wherein the drive arrangement comprises a cam associated with the reel and matingly engageable with a drive member such that engagement between the drive member and the cam drives the reel towards the datum position.

21. A device according to claim 1, further comprising thruster means operable to drive the device for movement relative to the sea bed.
